(19) United States
(12) Patent Application Publication
(10) Pub. No.: US 2025/0226696 A1
(43) Pub. Date: Jul. 10, 2025

(54) WIRELESS CHARGING CONTROL CIRCUIT, WIRELESS CHARGING TRANSMITTER CIRCUIT, AND CHIP

(71) Applicant: Zhuhai Nanxin Semiconductor Technology Co., Ltd, Zhuhai City (CN)

(72) Inventor: Lixu Gao, Zhuhai City (CN)

(21) Appl. No.: 19/009,725

(22) Filed: Jan. 3, 2025

(30) Foreign Application Priority Data
Jan. 5, 2024 (CN) 202410023366.4

(51) Int. Cl. H02J 50/12; H02M 7/53846; H02M 7/53862; H02M 7/5387

(52) U.S. Cl. CPC H02J 50/12; H02M 7/538466; H02M 7/53862; H02M 7/53878

(57) ABSTRACT

A wireless charging control circuit includes at least one control sub-circuit. Each control sub-circuit is configured to, prior to turn-on of a target switching transistor based on a received PWM signal, send a pulse width adjustment instruction to a signal processor corresponding to the target switching transistor based on a voltage difference between a first terminal and a second terminal of the target switching transistor, to instruct the signal processor to adjust a pulse width of a next PWM signal input to the target switching transistor. In this way, the wireless charging control circuit is capable of adaptively regulating the pulse width of the PWM signal, which avoids excessively large or small dead times, such that electromagnetic interference is prevented and conversion efficiency of a charging circuit is improved.

### CROSS-REFERENCE TO RELATED APPLICATION

This application is based upon and claims the priority of Chinese Patent Application No. 202410023366.4, filed on Jan. 5, 2024, the entire content of which is hereby incorporated by reference herein and made a part of this specification.

### TECHNICAL FIELD

The present disclosure relates to the technical field of electronics, and in particular, relates to a wireless charging control circuit, a wireless charging transmitter circuit, and a chip.

### BACKGROUND

With the development of technologies, terminal devices may be charged based on wireless charging systems. A wireless charging system typically includes a wireless charging transmitter circuit and a wireless charging receiver circuit. The wireless charging transmitter circuit includes two branches, wherein switching transistors on different branches are alternately turned on to convert an input direct current (DC) voltage signal into an alternating current (AC) voltage signal via inductors on the branches, and transmit the AC voltage signal to the wireless charging receiver circuit. During operation, the wireless charging transmitter circuit needs to avoid simultaneous turn-on of the switching transistors on different branches. Therefore, it is necessary to decrease pulse widths of pulse signals input to control terminals of the switching transistors, such that dead times are generated between upper and lower transistors.

In practical operation, in the case that the dead times are set too long, conversion efficiency of the wireless charging system may be affected. Conversely, where the dead times are set too short, the switching transistors in the wireless charging transmitter circuit may not be turned on at zero voltage, leading to some electromagnetic interference in the circuit. Therefore, how to adaptively adjust the dead time is an urgent issue that needs to be addressed.

### SUMMARY

Embodiments of the present disclosure provide a wireless charging control circuit, a wireless charging transmitter circuit, a chip, and a charger, such that a pulse width adjustment instruction is sent to a target switching transistor based on a voltage difference between two terminals of the target switching transistor prior to turn-on of the target switching transistor to regulate a pulse width of a next pulse width modulation (PWM) signal input to the target switching transistor. In this way, an excessively long or short dead time is prevented, which helps prevent electromagnetic interference and improve conversion efficiency of a wireless charging system.

In a first aspect, the embodiments of the present disclosure provide a wireless charging control circuit. The wireless charging control circuit is configured to control a PWM signal processing circuit to adjust a pulse width of an input PWM signal, a PWM signal output by the PWM signal processing circuit is used as a drive signal of a switching transistor in a wireless charging transmitter circuit; and the wireless charging control circuit includes: at least one control sub-circuit; wherein the wireless charging transmitter circuit includes an inverter circuit and an oscillator circuit, the inverter circuit includes a first switching transistor, a second switching transistor, a third switching transistor, and a fourth switching transistor; wherein the first switching transistor, the oscillator circuit, and the fourth switching transistor are sequentially connected in series to form a first branch, the second switching transistor, the oscillator circuit, and the third switching transistor are sequentially connected in series to form a second branch, wherein a first terminal of the first branch and a first terminal of the second branch are both connected to a DC power terminal, and a second terminal of the first branch and a second terminal of the second branch are both grounded; the PWM signal processing circuit is configured to control the first branch and the second branch to be alternately turned on, to convert a DC voltage signal supplied by the DC power terminal into an AC voltage signal via the oscillator circuit and transmit the AC voltage signal to a wireless charging receiver circuit; and the PWM signal processing circuit includes signal processors respectively corresponding to the first switching transistor, the second switching transistor, the third switching transistor, and the fourth switching transistor; wherein any of the signal processors is configured to adjust a pulse width of an input PWM signal based on a pulse width adjustment instruction from the control sub-circuit, and output the input PWM signal with the width adjusted to a corresponding switching transistor; the control sub-circuit corresponds to a target switching transistor, wherein the target switching transistor is any one of the first switching transistor, the second switching transistor, the third switching transistor, and the fourth switching transistor; and an input terminal of the control sub-circuit is electrically connected to a first terminal of the target switching transistor, and an output terminal of the control sub-circuit is electrically connected to a signal processor corresponding to the target switching transistor; and the control sub-circuit is configured to, prior to turn-on of the target switching transistor based on a received PWM signal, send a pulse width adjustment instruction to the signal processor corresponding to the target switching transistor based on a voltage difference between the first terminal of the target switching transistor and a second terminal of the target switching transistor, to instruct the signal processor corresponding to the target switching transistor to adjust a pulse width of a next PWM signal input to the target switching transistor based on the pulse width adjustment instruction.

In some embodiments, the control sub-circuit includes a sampler circuit, a comparator, and a pulse width adjustment instruction generator circuit; wherein one input terminal of the sampler circuit is electrically connected to the first terminal of the target switching transistor, and another input terminal of the sampler circuit is electrically connected to the second terminal of the target switching transistor; an output terminal of the sampler circuit is electrically connected to a positive pin of the comparator; a negative pin of the comparator is connected to a reference voltage signal, an output terminal of the comparator is connected to an input terminal of the pulse width adjustment instruction generator circuit, and an output terminal of the pulse width adjustment instruction generator circuit is electrically connected to the signal processor corresponding to the target switching transistor; the sampler circuit is configured to, prior to turn-on of the target switching transistor, sample voltage signals at the first terminal of the target switching transistor and the second terminal of the target switching transistor, and output a voltage difference signal indicating a voltage difference between the first terminal of the target switching transistor and the second terminal of the target switching transistor; the comparator is configured to output a comparison result to the pulse width adjustment instruction generator circuit based on the voltage difference signal and the reference voltage signal; and the pulse width adjustment instruction generator circuit is configured to generate the pulse width adjustment instruction based on the comparison result.

In some embodiments, the pulse width adjustment instruction includes a first pulse width adjustment instruction and a second pulse width adjustment instruction; and the pulse width adjustment instruction generator circuit is configured to: in a case that the comparison result indicates that an amplitude of the voltage difference signal is greater than an amplitude of the reference voltage signal, send the first pulse width adjustment instruction to the signal processor corresponding to the target switching transistor, to instruct the signal processor corresponding to the target switching transistor to decrease a pulse width of a next output PWM signal; or in a case that the comparison result indicates that an amplitude of the voltage difference signal is less than an amplitude of the reference voltage signal, send the second pulse width adjustment instruction to the signal processor corresponding to the target switching transistor, to instruct the signal processor corresponding to the target switching transistor to increase a pulse width of a next output PWM signal.

In some embodiments, the first terminal of the target switching transistor is a terminal, close to the oscillator circuit, of the target switching transistor, and the second terminal of the target switching transistor is a terminal, away from the oscillator circuit, of the target switching transistor.

In some embodiments, the target switching transistor is a switching transistor, close to the DC power terminal, on a branch where the target switching transistor is arranged, and the sampler circuit includes a first switch, a second switch, a third switch, a fourth switch, and a first capacitor; wherein a first terminal of the first switch, as one input terminal of the sampler circuit, is electrically connected to the first terminal of the target switching transistor, a first terminal of the second switch, as another input terminal of the sampler circuit, is electrically connected to the direct current power terminal, a second terminal of the first switch is electrically connected to a second terminal of the second switch via the first capacitor, the second terminal of the first switch is further electrically connected to the positive pin of the comparator via the third switch, and the second terminal of the second switch is further electrically connected to a ground via the fourth switch; the first switch and the second switch are turned on prior to turn-on of the target switching transistor and the first capacitor is charged, such that a voltage difference between two terminals of the charged first capacitor is equal to a voltage difference between the first terminal of the target switching transistor and the second terminal of the target switching transistor; and the third switching transistor and the fourth switching transistor are turned on in the case that the voltage difference between two terminals of the first capacitor is equal to the voltage difference between the first terminal of the target switching transistor and the second terminal of the target switching transistor, such that the first capacitor is discharged and the voltage difference signal is input to the positive pin of the comparator.

In some embodiments, the target switching transistor is a switching transistor, close to the ground, on a branch where the target switching transistor is arranged, and the sampler circuit includes a first switch, a second switch, a third switch, a fourth switch, and a first capacitor; wherein a first terminal of the first switch, as one input terminal of the sampler circuit, is electrically connected to ground, a first terminal of the second switch, as another input terminal of the sampler circuit, is electrically connected to the first terminal of the target switching transistor, a second terminal of the first switch is electrically connected to a second terminal of the second switch via the first capacitor, the second terminal of the first switch is further electrically connected to the positive pin of the comparator via the third switch, and the second terminal of the second switch is further electrically connected to ground via the fourth switch; the first switch and the second switch are turned on prior to turn-on of the target switching transistor and the first capacitor is charged, such that a voltage difference between two terminals of the charged first capacitor is equal to a voltage difference between the first terminal of the target switching transistor and the second terminal of the target switching transistor; and the third switch and the fourth switch are turned on in the case that the voltage difference between two terminals of the first capacitor is equal to the voltage difference between the first terminal of the target switching transistor and the second terminal of the target switching transistor, such that the first capacitor is discharged and the voltage difference signal is input to the positive pin of the comparator.

In some embodiments, an amplitude of the reference voltage signal output by the reference signal generator circuit is less than or equal to a turn-on voltage of a body diode of the target switching transistor.

In some embodiments, in a case that an amplitude of the voltage difference signal is greater than an amplitude of the reference voltage signal, the comparator outputs a high level; or in a case that an amplitude of the voltage difference signal is less than an amplitude of the reference voltage signal, the comparator outputs a low level.

In some embodiments, the target switching transistor includes an N-type metal-oxide-semiconductor field-effect transistor (NMOS).

In a second aspect, the embodiments of the present disclosure provide a wireless charging transmitter circuit. The wireless charging transmitter circuit includes: an inverter circuit, an oscillator circuit, a PWM signal processing circuit, and a wireless charging control circuit according to the embodiments of the present disclosure; wherein the inverter circuit includes a first switching transistor, a second switching transistor, a third switching transistor, and a fourth switching transistor; wherein the first switching transistor, the oscillator circuit, and the fourth switching transistor are sequentially connected in series to form a first branch, the second switching transistor, the oscillator circuit, and the third switching transistor are sequentially connected in series to form a second branch, wherein a first terminal of the first branch and a first terminal of the second branch are both connected to a DC power terminal, and a second terminal of the first branch and a second terminal of the second branch are both grounded; the PWM signal processing circuit is configured to control the first branch and the second branch to be alternately turned on, to convert a DC voltage signal supplied by the DC power terminal into an AC voltage signal via the oscillator circuit and transmit the AC voltage signal to a wireless charging receiver circuit; and the PWM signal processing circuit includes signal processors respectively corresponding to the first switching transistor, the second switching transistor, the third switching transistor, and the fourth switching transistor; wherein any of the signal processors is configured to adjust a pulse width of an input PWM signal based on a pulse width adjustment instruction from the control sub-circuit, and output the input PWM signal with the width adjusted to a corresponding switching transistor.

In a third aspect, the embodiments of the present disclosure provide a chip. The chip includes the wireless charging control circuit according to the first aspect of the present disclosure, or the wireless charging transmitter circuit according to the second aspect of the present disclosure.

In a fourth aspect, the embodiments of the present disclosure provide a wireless charger. The wireless charger includes the chip according to the third aspect of the present disclosure.

In the wireless charging control circuit according to the embodiments of the present disclosure, prior to turn-on of the target switching transistor based on a received PWM signal, a pulse width adjustment instruction is sent to the signal processor corresponding to the target switching transistor based on a voltage difference between a first terminal of the target switching transistor and a second terminal of the target switching transistor, to instruct the signal processor to adjust, based on the pulse width adjustment instruction, a pulse width of a next PWM signal input to the target switching transistor to adjust a dead time between an upper transistor and a lower transistor in the wireless charging transmitter circuit. In this way, the wireless charging control circuit is capable of adaptively regulating the pulse width of the PWM signal based on the voltage difference between the two terminals of the target switching transistor, which avoids excessively large or small dead times, such that electromagnetic interference is prevented and conversion efficiency of the wireless charging system is improved.

### BRIEF DESCRIPTION OF THE DRAWINGS

FIG. 1 is a schematic structural diagram of a wireless charging transmitter circuit and a PWM signal processing circuit according to some embodiments of the present disclosure;

FIG. 2 is a schematic diagram of waveforms of PWM signals according to some embodiments of the present disclosure;

FIG. 3 is a schematic diagram of waveforms of a PWM signal and a voltage signal at an AC terminal according to some embodiments of the present disclosure;

FIG. 4 is a schematic diagram of waveforms at an AC terminal under different dead times according to some embodiments of the present disclosure;

FIG. 5 is a schematic circuit diagram of a wireless charging transmitter circuit, a PWM signal processing circuit, and a wireless charging control circuit according to some embodiments of the present disclosure;

FIG. 6 is a schematic circuit diagram of a control sub-circuit according to some embodiments of the present disclosure;

FIG. 7 is a schematic circuit diagram of a control sub-circuit according to some embodiments of the present disclosure;

FIG. 8 is a schematic circuit diagram of a control sub-circuit according to some embodiments of the present disclosure;

FIG. 9 is a schematic diagram of signal waveforms at different terminals according to some embodiments of the present disclosure; and

FIG. 10 is a schematic diagram of signal waveforms at different terminals according to some embodiments of the present disclosure.

### DETAILED DESCRIPTION

In the present disclosure, the term “at least one” refers to one or more than one, and the term “a plurality of” refers to two or more than two. The term “and/or” is merely an association relationship for describing associated objects, which represents that there may exist three types of relationships, for example, A and/or B may represent three situations: only A exists, both A and B exist, and only B exists, wherein A and B may be single or plural. In addition, the symbol “/” generally represents an “or” relationship between associated objects before and after the symbol. The expression “at least one of the following” or the like expression means any combination of the items or options listed, including a single item or option or any combination of plural items or options listed. For example, at least one of a single a, a single b, and a single c may indicate: the single a, the single b, the single c, a combination of a and b, a combination of a and c, a combination of b and c, or a combination of a, b, and c, wherein each of a, b, and c may be single or plural. In addition, the terms “first,” “second,” and the like are merely for the illustration purpose, and shall not be construed as indicating or implying a relative importance.

In the description of the present disclosure, it should be understood that the terms “central,” “transversal,” “longitudinal,” “upper,” “lower,” “left,” “right,” “front,” “rear,” and the like indicate orientations and position relationships which are based on the illustrations in the accompanying drawings, and these terms are merely for ease and brevity of the description, instead of indicating or implying that the devices or elements shall have a particular orientation and shall be structured and operated based on the particular orientation. Accordingly, these terms shall not be construed as limiting the present disclosure.

In the description of the present disclosure, unless otherwise explicitly specified and defined, the terms “connected,” “coupled,” and derivatives forms thereof shall be understood in a broad sense. For example, the terms “connected,” “coupled,” and derivatives form thereof for depicting the circuit structure, in addition to physical connection, may also be understood as electrical connections or signal connection. The connection, for example, may be direct connection, i.e., the physical connection or, indirect connection via at least one intermediate element as long as the circuit is conducted, or communication between the interiors of two elements. The signal connection, in addition to signal connection via a circuitry, may also be signal connection via a communication medium, for example, radio waves. Persons of ordinary skill in the art may understand specific meanings of the above terms in the present disclosure according to the actual circumstances and contexts.

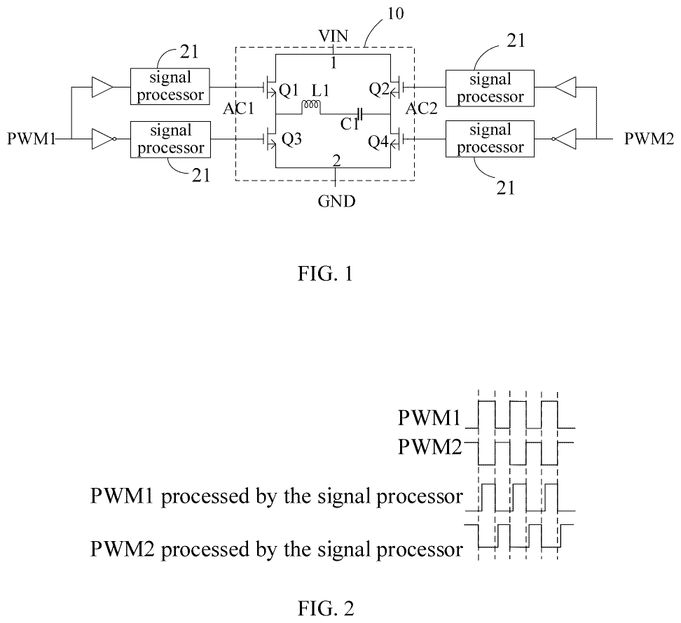

With the development of technologies, terminal devices may be charged based on wireless charging systems. A wireless charging system includes a wireless charging transmitter circuit and a wireless charging receiver circuit. FIG. 1 is a schematic structural diagram of a system including a wireless charging transmitter circuit 10 according to some embodiments of the present disclosure. As illustrated in FIG. 1, the wireless charging transmitter circuit 10 at least includes an inverter circuit 11 and an oscillator circuit LC. The inverter circuit 11 includes a first switching transistor Q1, a second switching transistor Q2, a third switching transistor Q3, and a fourth switching transistor Q4. The oscillator circuit LC includes a second capacitor C1 and an inductor L1. The first switching transistor Q1, the oscillator circuit LC, and the fourth switching transistor Q4 are sequentially connected in series to form a first branch. The second switching transistor Q2, the oscillator circuit LC, and the third switching transistor Q3 are sequentially connected in series to form a second branch. A first terminal of the first branch and a first terminal of the second branch are both connected to a DC power terminal, and a second terminal of the first branch and a second terminal of the second branch are both grounded. That is, as illustrated in FIG. 1, the first terminal of the first branch is coincident with the first terminal of the second branch, and the second terminal of the first branch is coincident with the second terminal of the second branch.

The wireless charging transmitter circuit 10 is connected to the PWM signal processing circuit 20. The PWM signal processing circuit 20 includes at least one signal processor. The PWM signal processing circuit 20 is configured to control the first branch and the second branch to be alternately turned on, to convert a DC voltage signal supplied by a DC power terminal into an AC voltage signal via the oscillator circuit LC, and transmit the AC voltage signal to a wireless charging receiver circuit (not illustrated in FIG. 1).

Specifically, in a first stage, the first switching transistor Q1 and the fourth switching transistor Q4 are turned on, and the second switching transistor Q2 and the third switching transistor Q3 are turned off; and in a second stage, the second switching transistor Q2 and the third switching transistor Q3 are turned on, and the first switching transistor Q1 and the fourth switching transistor Q4 are turned off, to convert a DC voltage signal supplied by the DC power terminal into an AC voltage signal.

As illustrated in FIG. 1, the PWM signal processing circuit 20 includes four signal processors 21 respectively corresponding to the first switching transistor Q1, the second switching transistor Q2, the third switching transistor Q3, and the fourth switching transistor Q4. That is, the PWM signal processing circuit 20 includes a signal processor 21 corresponding to the first switching transistor Q1, a signal processor 21 corresponding to the second switching transistor Q2, a signal processor 21 corresponding to the third switching transistor Q3, and a signal processor 21 corresponding to the fourth switching transistor Q4. In the case that the wireless charging transmitter circuit 10 is not connected to a control sub-circuit, the PWM signal processing circuit 20 is configured to shorten a pulse width of an input PWM signal. That is, each of the signal processors 21 of the PWM signal processing circuit shortens the pulse width of the input PWM signal, such that dead times are caused between the first branch and the second branch, and thus the first branch and the second branch are alternately turned on.

Specifically, as illustrated in FIG. 2, the PWM signal input to the signal processor 21 includes a first PWM1 signal and a second PWM2 signal. Phases of the first PWM1 signal and the second PWM2 signal are opposite, a rising edge of the first PWM1 signal is coincident with a falling edge of the second PWM2 signal, and a falling edge of the first PWM1 signal is coincident with a rising edge of the second PWM2 signal. In the case that the wireless charging transmitter circuit is not connected to a signal processor 21, an instant when the first switching transistor Q1 comes into a turned-off state from a turned-on state is coincident with an instant when the third switching transistor Q3 comes into a turned-on state from a turned-off state, or an instant when the fourth switching transistor Q4 comes into a turned-off state from a turned-on state is coincident with an instant when the second switching transistor Q2 comes into a turned-on state from a turned-off state. In this way, the first switching transistor Q1 and the third switching transistor Q3 turn on at the same time, or the fourth switching transistor Q4 and the second switching transistor Q2 turn on at the same time, such that an AC voltage signal may not be properly generated, and the wireless charging system operates improperly.

In the case that the wireless charging transmitter circuit is connected to a signal processor 21, the signal processor 21 shortens the pulse width of the input PWM signal, and inputs the processed PWM signal to a control terminal of the switching transistor. Herein, the shortened time is referred to as a dead time.

The control terminal of the switching transistor may be a gate electrode of the switching transistor.

Upon shortening a pulse width of the input PWM signal, the signal processor outputs a processed PWM signal. Due to presence of the dead time, a waveform of the PWM signal that is processed by the signal processor 21 and input to the control terminal of the switching transistor is as illustrated in FIG. 2. The rising edge of the processed first PWM1 signal is not coincident with the falling edge of the processed second PWM2 signal, and the falling edge of the processed first PWM1 signal is not coincident with the rising edge of the processed second PWM2 signal. In this case, the instant when the first switching transistor Q1 comes into the turn-off state from the turn-on state is not coincident with the instant when the third switching transistor Q3 comes into the turn-on state from the turn-off state, and the instant when the fourth switching transistor Q4 comes into the turn-off state from the turn-on state is not coincident with the instant when the second switching transistor Q2 comes into the turn-on state from the turn-off state. In this way, the first switching transistor Q1 and the fourth switching transistor Q4 on the first branch are alternately turned on with the second switching transistor Q2 and the third switching transistor Q3 on the second branch, such that an input DC signal is converted into an AC signal and the AC signal is transmitted to a receiver circuit in the wireless charging system.

The switching transistors in FIG. 1 may be NMOS transistors, or may be P-channel metal-oxide-semiconductor (PMOS) transistors. Specifically, the first switching transistor Q1, the second switching transistor Q2, the third switching transistor Q3, and the fourth switching transistor Q4 are NMOS transistors; or the first switching transistor Q1 and the second switching transistor Q2 are PMOS transistors, and the third switching transistor Q3 and the fourth switching transistor Q4 are NMOS transistors. In the wireless charging transmitter circuit, the first switching transistor Q1 and the second switching transistor Q2 close to a DC input terminal VIN are referred to as upper transistors, and the third switching transistor Q3 and the fourth switching transistor Q4 close to ground are referred to as lower transistors. In the case that the first switching transistor Q1 and the second switching transistor Q2 are NMOS transistors, the first terminals of the first branch and the second branch are drain electrodes of the upper transistors. In the case that the first switching transistor Q1 and the second switching transistor Q2 are PMOS transistors, the first terminals of the first branch and the second branch are source electrodes of the upper transistors. Second terminals of the first branch and the second branch are source electrodes of the lower transistors.

As described above, the signal processor 21 performs shortening processing on the input PWM signal, such that a dead time is present between the upper transistor and the lower transistor, which prevents the upper transistor and the lower transistor turn on at the same time. In the case that the dead time between the upper transistor and the lower transistor is set to be shorter, a parasitic capacitor of the inductor L1 discharges, that is, the voltage at the first terminal AC1 of the first switching transistor or the second switching transistor, or at the second terminal AC2 of the third switching transistor or the fourth switching transistor fails to achieve zero voltage switching (ZVS). Specifically, a voltage at the first terminal AC1 when the first switching transistor Q1 and the third switching transistor Q3 are switched from the turned-off state to the turned-on state is not zero, or a voltage at the second terminal AC2 when the second switching transistor Q2 and the fourth switching transistor Q4 are switched from the turned-off state to the turned-on state is not zero. In this way, damages may be caused to the switching transistors, and electromagnetic interference may be caused. In the case that the dead time is excessively long, the body diodes of the switching transistors are in the turned-on state for a long time, such that conversion efficiency of the wireless charging system is adversely affected.

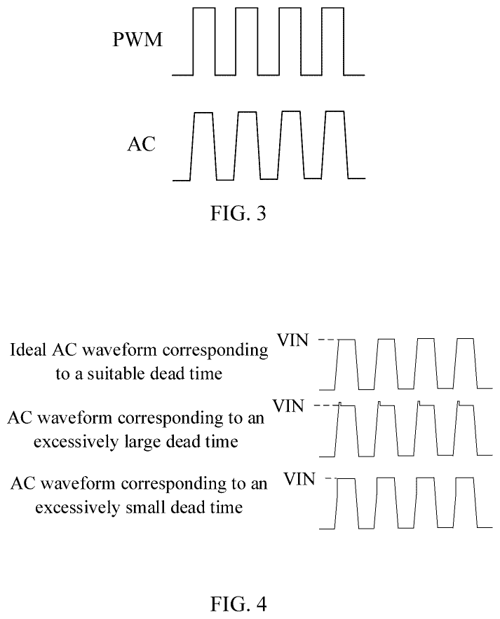

In the case that the dead time is present, waveforms of an input PWM signal (including the first PWM1 signal and the second PWM2 signal) and a voltage signal at an AC terminal (including the first terminal AC1 and the second terminal AC2) are illustrated in FIG. 3. Due to presence of the inductor L1, the voltage signal at the AC terminal rises from a low level to a high level through a slow rising course. FIG. 3 illustrates a schematic diagram of a waveform of the voltage signal at the AC terminal under a reasonably set dead time. FIG. 4 illustrates a schematic diagram of waveforms of the voltage signal at the AC terminal under a long dead time and a short dead time.

In the case that a longer dead time is set for the upper transistor and the lower transistor, referring to FIG. 1, exemplarily, after the second switching transistor Q2 and the third switching transistor Q3 are turned off, within a long time period, the first switching transistor Q1 and the fourth switching transistor Q4 are not turned on. During this time period, the parasitic capacitor on the inductor L1 starts discharging, such that the voltage at the first terminal AC1 rises. After the voltage at the first terminal AC1 rises to the voltage at the DC input terminal VIN, using the first switching transistor Q1 as an example, the body diode of the first switching transistor Q1 is turned on. Where the first switching transistor Q1 is an NMOS transistor, a turn-on direction of the body diode of the first switching transistor Q1 is from a source electrode to a drain electrode. In this case, a source-to-drain voltage (that is, the voltage at the first terminal AC1) of the first switching transistor Q1 is equal to the voltage of the body diode of the first switching transistor Q1 relative to a drain-to-source voltage (the voltage at the DC input terminal VIN). As illustrated in FIG. 4, the voltage at the AC terminal sharply rises relative to the voltage at the DC input terminal VIN. Upon turn-on of the first switching transistor Q1, a low-impedance path (or a direct connection or a short circuit) is established between the drain electrode and the source electrode of the first switching transistor Q1, and the voltage at the AC terminal sharply drops back to the voltage at the DC input terminal VIN. In this case, prior to turn-on of the first switching transistor Q1, a brief small spike may appear in a voltage waveform at the AC terminal.

In the case that the dead time is set too short, in the case that the second switching transistor Q2 and the third switching transistor Q3 are turned off, the parasitic capacitor in the inductor L1 starts discharging, and in the case that the voltage at the AC terminal does not rise to the voltage at the DC input terminal VIN, the first switching transistor Q1 is turned on. As illustrated in FIG. 4, in the case that the voltage at the AC terminal does not yet rise to the voltage of the DC input terminal VIN, since the first switching transistor Q1 is turned on, a low-impedance path (or a direct connection or a short circuit) is established between the source electrode and the drain electrode, such that the voltage at the AC terminal quickly reaches the voltage at the DC input terminal VIN.

Accordingly, an embodiment of the present disclosure provides a wireless charging control circuit 30, which is capable of controlling the PWM signal processing circuit 20 to adjust the pulse width of the input PWM signal, and adaptively regulating the dead time between the upper transistor and the lower transistor to prevent the dead time being set excessively large or excessively small. In this way, the dead time is reasonably set, such that electromagnetic interference is reduced, and conversion efficiency of the wireless charging system is improved.

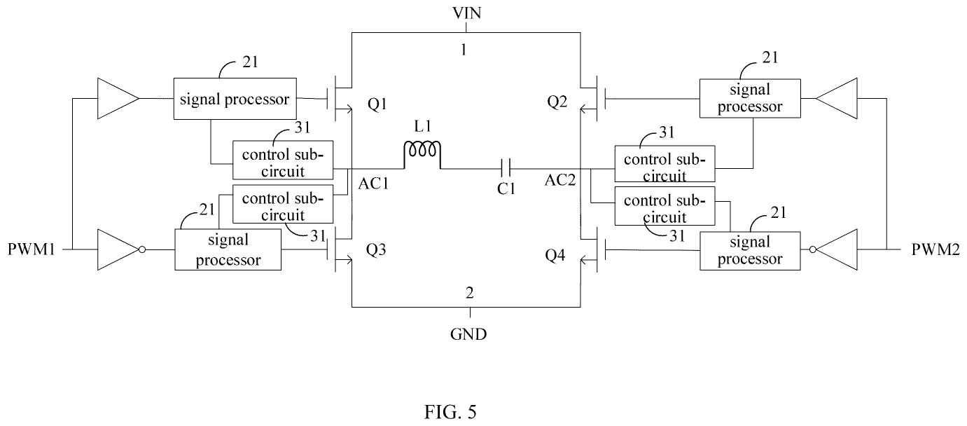

FIG. 5 is a schematic structural diagram of a wireless charging control circuit 30 according to some embodiments of the present disclosure. As illustrated in FIG. 5, the wireless charging control circuit 30 includes at least one control sub-circuit 31. The control sub-circuit 31 corresponds to a target switching transistor. The target switching transistor is any one of a first switching transistor Q1, a second switching transistor Q2, a third switching transistor Q3, and a fourth switching transistor Q4. An input terminal of the control sub-circuit 31 is electrically connected to a first terminal of the target switching transistor, and an output terminal of the control sub-circuit 31 is electrically connected to the signal processor 21 corresponding to the target switching transistor.

In some embodiments, the first terminal of the target switching transistor is a terminal, close to the oscillator circuit, of the target switching transistor. FIG. 5 illustrates a schematic structural diagram of a transmitter circuit and a control circuit in the case that the target switching transistor is an NMOS transistor.

As illustrated in FIG. 5, in the case that the target switching transistor is the first switching transistor Q1 or the second switching transistor Q2, the first terminal of the target switching transistor is the first terminal AC1, that is, the first terminal of the target switching transistor is a source electrode of the target switching transistor, and the input terminal AC1 of the control sub-circuit 31 is electrically connected to the source electrode of the target switching transistor.

As illustrated in FIG. 5, in the case that the target switching transistor is the third switching transistor Q3 or the fourth switching transistor Q4, the first terminal of the target switching transistor is the second terminal AC2, that is, the first terminal of the target switching transistor is a source electrode of the target switching transistor, and the input terminal AC2 of the control sub-circuit 31 is electrically connected to the source electrode of the target switching transistor.

In the case that the target switching transistor is the first switching transistor Q1 or the second switching transistor Q2, the first switching transistor Q1 and the second switching transistor Q2 may also be PMOS transistors. In this case, the first terminal of the target switching transistor is the first terminal AC1, that is, the first terminal of the target switching transistor is a drain electrode of the target switching transistor, and the input terminal AC1 of the control sub-circuit 31 is electrically connected to the drain electrode of the target switching transistor.

The control sub-circuit 31 in the wireless charging control circuit 30 is configured to, prior to turn-on of the target switching transistor based on a received PWM signal, send a pulse width adjustment instruction to the signal processor 21 corresponding to the target switching transistor based on a voltage difference between the first terminal of the target switching transistor and a second terminal of the target switching transistor, to instruct the signal processor 21 to adjust a pulse width of a next PWM signal input to the target switching transistor based on the pulse width adjustment instruction.

As illustrated in FIG. 5, in the case that the target switching transistor is the first switching transistor Q1 or the second switching transistor Q2, the second terminal of the target switching transistor is the drain electrode of the target switching transistor, the second terminal of the target switching transistor is electrically connected to the DC input terminal VIN, and a voltage difference between the first terminal and the second terminal of the target switching transistor is equal to a voltage difference between the first terminal AC1 and the DC input terminal VIN.

In the case that the target switching transistor is the third switching transistor Q3 or the fourth switching transistor Q4, the second terminal of the target switching transistor is the source electrode of the target switching transistor, the second terminal of the target switching transistor is electrically connected to the ground GND, and a voltage difference between the first terminal and the second terminal of the target switching transistor is equal to a voltage difference between the first terminal AC1 and the ground GND.

As illustrated in FIG. 5, in the case that the target switching transistor is the first switching transistor Q1, the control sub-circuit 31 corresponding to the first switching transistor Q1 is configured to, prior to turn-on of the first switching transistor Q1, send a pulse width adjustment instruction to the signal processor 21 corresponding to the first switching transistor Q1 based on a voltage difference between the DC input terminal VIN and the first terminal AC1, to instruct the signal processor 21 corresponding to the first switching transistor Q1 to adjust, based on the pulse width adjustment instruction, a pulse width of a next PWM signal input to the first switching transistor Q1.

In the case that the target switching transistor is the second switching transistor Q2, the control sub-circuit 31 corresponding to the second switching transistor Q2 is configured to, prior to turn-on of the second switching transistor Q2, send a pulse width adjustment instruction to the signal processor 21 corresponding to the second switching transistor Q2 based on a voltage difference between the second terminal AC2 and the DC input terminal VIN, to instruct the signal processor 21 corresponding to the second switching transistor Q2 to adjust, based on the pulse width adjustment instruction, a pulse width of a next PWM signal input to the second switching transistor Q2.

In the case that the target switching transistor is the third switching transistor Q3, the control sub-circuit 31 corresponding to the third switching transistor Q3 is configured to, prior to turn-on of the third switching transistor Q3, send a pulse width adjustment instruction to the signal processor 21 corresponding to the third switching transistor Q3 based on a voltage difference between the first terminal AC1 and the ground GND, to instruct the signal processor 21 corresponding to the third switching transistor Q3 to adjust, based on the pulse width adjustment instruction, a pulse width of a next PWM signal input to the third switching transistor Q3.

In the case that the target switching transistor is the fourth switching transistor Q4, the control sub-circuit 31 corresponding to the fourth switching transistor Q4 is configured to, prior to turn-on of the fourth switching transistor Q4, send a pulse width adjustment instruction to the signal processor 21 corresponding to the fourth switching transistor Q4 based on a voltage difference between the second terminal AC2 and the ground GND, to instruct the signal processor 21 corresponding to the fourth switching transistor Q4 to adjust, based on the pulse width adjustment instruction, a pulse width of a next PWM signal input to the fourth switching transistor Q4.

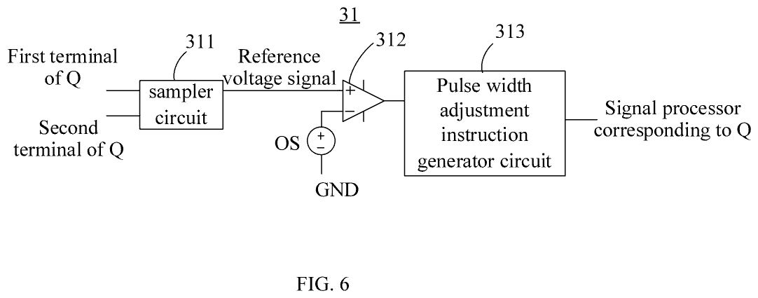

FIG. 6 illustrates a schematic structural diagram of a control sub-circuit 31. The control sub-circuit 31 includes a sampler circuit 311, a comparator circuit 312, and a pulse width adjustment instruction generator circuit 313.

In FIG. 6, one input terminal of the sampler circuit 311 is electrically connected to the first terminal of the target switching transistor Q (which is the first switching transistor Q1, the second switching transistor Q2, the third switching transistor Q3, or the fourth switching transistor Q4), and another input terminal of the sampler circuit 311 is electrically connected to the second terminal of the target switching transistor Q; an output terminal of the sampler circuit 311 is electrically connected to a positive pin of the comparator 312; and a negative pin of the comparator 312 is configured to receive a reference voltage signal, and an output terminal of the comparator 312 is electrically connected to an input terminal of the pulse width adjustment instruction generator circuit 313.

Specifically, the negative pin of the comparator 312 is connected to the ground GND via a reference voltage signal generator circuit OS. The reference voltage signal generator circuit OS is configured to output a reference voltage signal to the negative pin of the comparator 312, wherein an amplitude of the reference voltage signal is less than or equal to a turn-on voltage of the target switching transistor Q, and the amplitude of the reference voltage signal indicates a voltage value.

An output terminal of the pulse width adjustment instruction generator circuit 313 is electrically connected to the signal processor 21 corresponding to the target switching transistor Q. The pulse width adjustment instruction generator circuit 313 is an instruction generator circuit configured to generate a pulse width adjustment instruction.

The sampler circuit 31 is configured to, prior to turn-on of the target switching transistor Q, sample voltage signals at the first terminal of the target switching transistor Q and the second terminal of the target switching transistor Q, and output a voltage difference signal indicating a voltage difference between the first terminal of the target switching transistor Q and the second terminal of the target switching transistor Q.

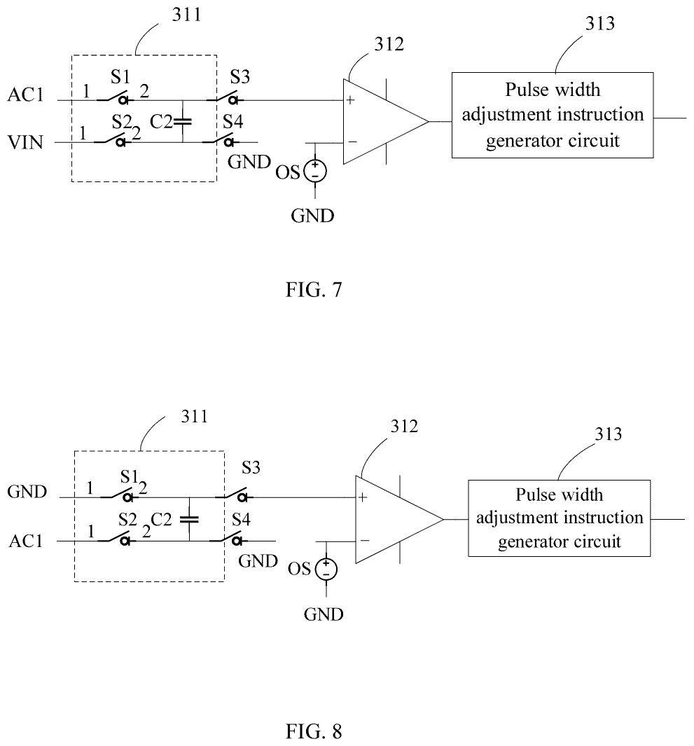

As illustrated in FIG. 7, the sampler circuit 311 includes a first switch S1, a second switch S2, a third switch S3, a fourth switch S4, and a first capacitor C2; the target switching transistor Q may be any one of the first switching transistor Q1, the second switching transistor Q2, the third switching transistor Q3, and the fourth switching transistor Q4; switching transistors, close to the DC power terminal, on the branch, for example, the first switching transistor Q1 and the second switching transistor Q2 as illustrated in FIG. 1 or FIG. 5, may be referred to as upper transistors; and switching transistors, close to a ground, on the branch, for example, the third switching transistor Q3 and the fourth switching transistor Q4 as illustrated in FIG. 1 or FIG. 5, may be referred to as lower transistors.

In the case that the target switching transistor Q is an upper transistor, as illustrated in FIG. 7, a first terminal of the first switch S1, as one input terminal of the sampler circuit, is electrically connected to the first terminal of the target switching transistor Q, a first terminal of the second switch S2, as another input terminal of the sampler circuit, is electrically connected to the DC input terminal VIN, a second terminal of the first switch S1 is electrically connected to a second terminal of the second switch S2 via the first capacitor C2, the second terminal of the first switch S1 is further electrically connected to the positive pin of the comparator 312 via the third switch S3, and the second terminal of the second switch S2 is further electrically connected to the ground GND via the fourth switch S4.

In the case that the target switching transistor Q is a lower transistor, as illustrated in FIG. 8, a first terminal of the first switch S1, as one input terminal of the sampler circuit 311, is electrically connected to the ground GND, a first terminal of the second switch S2, as another input terminal of the sampler circuit, is electrically connected to the first terminal of the target switching transistor Q, a second terminal of the first switch S1 is electrically connected to a second terminal of the second switch S2 via the first capacitor C2, the second terminal of the first switch S1 is further electrically connected to the positive pin of the comparator 312 via the third switch S3, and the second terminal of the second switch S2 is further electrically connected to the ground GND via the fourth switch S4.

The first switch S1 and the second switch S2 are turned on prior to turn-on of the target switching transistor Q and the first capacitor C2 is charged, such that a voltage difference between two terminals of the charged first capacitor C2 is equal to a voltage difference between the first terminal of the target switching transistor Q and the second terminal of the target switching transistor Q.

The third switch S3 and the fourth switch S4 are turned on in the case that the voltage difference between two terminals of the first capacitor C2 is equal to the voltage difference between the first terminal of the target switching transistor Q and the second terminal of the target switching transistor Q, such that the first capacitor C2 is discharged and the voltage difference signal is input to the positive pin of the comparator 312.

It should be noted that regardless of an upper transistor or a lower transistor, in the case that the first switch S1 and the second switch S2 in the sampler circuit are turned on such that the first capacitor C2 is charged, the third switch S3 and the fourth switch S4 are in a turned-off state; and in the case that the first capacitor C2 is charged such that a voltage difference between two terminals thereof is equal to the voltage difference between the first terminal and the second terminal of the target switching transistor Q, the first switch S1 and the second switch S2 are turned off, and in the meantime, the third switch S3 and the fourth switch S4 are turned on, such that the first capacitor C2 is discharged.

The comparator 312 is configured to output a comparison result to the pulse width adjustment instruction generator circuit 313 based on the voltage difference signal and the reference voltage signal.

The pulse width adjustment instruction generator circuit 313 is configured to generate a pulse width adjustment instruction based on the comparison result, and send the pulse width adjustment instruction to the signal processor 21 corresponding to the target switching transistor Q, such that the signal processor 21 corresponding to the target switching transistor Q adjusts a pulse width of a next PWM signal input to the target switching transistor Q based on the pulse width adjustment instruction.

The pulse width adjustment instruction includes a first pulse width adjustment instruction and a second pulse width adjustment instruction.

In the case that the comparison result indicates that an amplitude of the voltage difference signal is greater than the amplitude of the reference voltage signal, the pulse width adjustment instruction generator circuit 313 sends the first pulse width adjustment instruction to the signal processor 21 corresponding to the target switching transistor Q, to instruct the signal processor 21 corresponding to the target switching transistor Q to decrease a pulse width of a next input PWM signal; or in the case that the comparison result indicates that an amplitude of the voltage difference signal is less than the amplitude of the reference voltage signal, the pulse width adjustment instruction generator circuit 313 sends the second pulse width adjustment instruction to the signal processor 21 corresponding to the target switching transistor Q, to instruct the signal processor 21 corresponding to the target switching transistor Q to increase a pulse width of a next input PWM signal. The amplitude of the voltage difference signal indicates a voltage value, and the amplitude of the reference voltage signal indicated a voltage value.

Specifically, in the case that the amplitude of the voltage difference signal is greater than the amplitude of the reference voltage signal, the comparison result output by the comparator 312 to the pulse width adjustment instruction generator circuit 313 is a high level signal, and the pulse width adjustment instruction generator circuit 313 sends the first pulse width adjustment instruction to the signal processor 21 corresponding to the target switching transistor Q based on the received high level signal. The first pulse width adjustment instruction instructs the signal processor 21 corresponding to the target switching transistor Q to decrease a pulse width of a next output PWM signal.

In the case that the amplitude of the voltage difference signal is less than the amplitude of the reference voltage signal, the comparison result output by the comparator 312 to the pulse width adjustment instruction generator circuit 313 is a low level signal, and the pulse width adjustment instruction generator circuit 313 sends the second pulse width adjustment instruction to the signal processor 21 corresponding to the target switching transistor Q based on the received low level signal. The second pulse width adjustment instruction instructs the signal processor 21 corresponding to the target switching transistor Q to increase a pulse width of a next output PWM signal.

By an example where the first switching transistor Q1 is an upper transistor, a specific connection between the wireless charging transmitter circuit 10 and the wireless charging control circuit 20 is described, and principles of adjusting a pulse width of a next PWM signal input to the third switching transistor Q3 are described.

Exemplarily, as illustrated in FIG. 7, the target switching transistor is the first switching transistor Q1 as an upper transistor, the first terminal of the first switch S1 is electrically connected to the first terminal AC1 of the first switching transistor Q1, the first terminal of the second switch S2 is electrically connected to the DC input terminal VIN, the second terminal of the first switch S1 is further electrically connected to the second terminal of the second switch S2 via the first capacitor C2, the second terminal of the first switch S1 is further electrically connected to the positive pin of the comparator 312 via the third switch S3, and the second terminal of the second switch S2 is further electrically connected to the ground GND via the fourth switch S4.

The first switch S1 and the third switch S2 are turned on prior to turn-on of the first switching transistor Q1, such that the first capacitor C2 is charged. In the case that a voltage difference of the first capacitor C2 is equal to the voltage difference between the first terminal AC1 and the DC input terminal VIN, the third switch S3 and the fourth switch S4 are turned on, such that the first capacitor C2 is discharged.

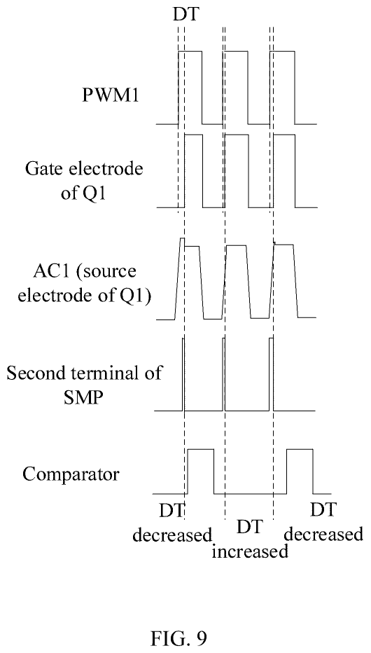

FIG. 9 is a schematic diagram of waveforms at some terminals of the circuit in FIG. 5. As illustrated in FIG. 9, the signal processor corresponding to the first switching transistor Q decreases the pulse width of the input first PWM1 signal to form a dead time DT. In the case that a small peak is present for the width of the pulse signal output by the first terminal AC1 as illustrated in FIG. 9, the dead time is too long. Before the PWM signal input to the first switching transistor Q1 becomes a high level, that is, prior to turn-on of the first switching transistor Q1, the first switch S1 and the second switch S2 are turned on, such that the first capacitor C2 is in a charging state. In the case that the voltage difference between the two terminals of the first capacitor C2 is equal to the voltage difference between the first terminal and the second terminal of the first switching transistor Q1, the first switch S1 and the second switch S2 are turned off, and the third switch S3 and the fourth switch S4 are turned on, such that the voltage at the positive pin of the comparator is a voltage difference between the drain electrode and the source electrode of the first switching transistor Q1.

In the case that the voltage difference between the drain electrode and the source electrode of the first switching transistor Q1 is greater than the amplitude of the reference voltage signal, a body diode between the source electrode and the drain electrode of the first switching transistor Q1 is turned on, which indicates that the dead time is too long. Therefore, the pulse width adjustment instruction generator circuit 313 sends a first pulse width adjustment instruction to the signal processor 21 corresponding to the first switching transistor Q1, to instruct the signal processor 21 corresponding to the first switching transistor Q1 to decrease a pulse with of a next input PWM signal.

In the case that the voltage difference between the drain electrode and the source electrode of the first switching transistor Q1 is less than the amplitude of the reference voltage signal, the body diode between the source electrode and the drain electrode of the first switching transistor Q1 is not turned on, which indicates that the dead time is too short. Therefore, the pulse width adjustment instruction generator circuit 313 sends a second pulse width adjustment instruction to the signal processor 21 corresponding to the first switching transistor Q1, to instruct the signal processor 21 corresponding to the first switching transistor Q1 to decrease the pulse with of a next input PWM signal.

By an example where the third switching transistor Q3 is a lower transistor, a specific connection between the wireless charging transmitter circuit and the wireless charging control circuit is described, and principles of adjusting a pulse width of a next PWM signal input to the third switching transistor Q3 are described.

In the case that the target switching transistor is the third switching transistor Q3, the first terminal of the first switch S1 is electrically connected the ground GND, the first terminal of the second switch S2 is electrically connected to the second terminal AC2, the second terminal of the first switch S1 is electrically connected to the second terminal of the second switch S2 via the first capacitor C2, the second terminal of the first switch S1 is electrically connected to the positive pin of the comparator 312 via the third switch S3, and the second terminal of the second switch S2 is grounded via the fourth switch S4.

The first switch S1 and the third switch S2 are turned on prior to turn-on of the third switching transistor Q3, such that the first capacitor C2 is charged. In the case that a voltage difference between the two terminals of the first capacitor C2 is equal to the voltage difference between the second terminal AC2 and the ground GND, the third switch S3 and the fourth switch S4 are turned on, such that the first capacitor C2 is discharged.

During discharge of the first capacitor C2, one terminal of the first capacitor C2 is grounded, and another terminal of the first capacitor C2 is connected to the positive pin of the comparator, and an amplitude of a voltage difference signal input to the positive pin of the comparator is equal to the voltage difference between the two terminals of the first capacitor C2.

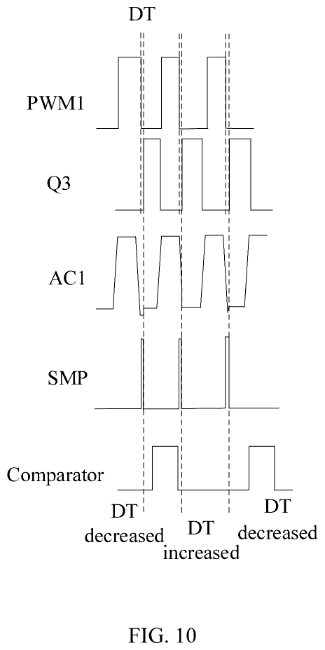

FIG. 10 is a schematic diagram of waveforms at some terminals in the circuit in FIG. 5. The signal processor 21 corresponding to the third switching transistor Q3 decreases the pulse width of the input first PWM1 signal to form a dead time DT. In the case that a downward small peak is present for the width of the pulse signal output by the first terminal AC1 as illustrated in FIG. 10, the dead time is too long. Before the input first PWM1 signal becomes a high level, that is, prior to turn-on of the third switching transistor Q3, the first switch S1 and the second switch S2 are turned on, such that the first capacitor C2 is in a charging state. In the case that the voltage difference between the two terminals of the first capacitor C2 is equal to a voltage difference between a first terminal and a second terminal of the third switching transistor Q3, the first switch S1 and the second switch S2 are turned off, and the third switch S3 and the fourth switch S4 are turned on, such that the voltage at the positive pin of the comparator is equal to a voltage difference between the drain electrode and the source electrode of the third switching transistor Q3. In the case that the voltage difference between the drain electrode and the source electrode of the third switching transistor Q3 is greater than the amplitude of the reference voltage signal, a body diode between the source electrode and the drain electrode of the third switching transistor Q3 is turned on, which indicates that the dead time is too long. Therefore, the pulse width adjustment signal generator circuit 313 sends the first pulse width adjustment instruction to the signal processor 21 corresponding to the target switching transistor, i.e., the third switching transistor Q3, to instruct the signal processor 21 corresponding to the target switching transistor to decrease the pulse width of the next input PWM signal.

In the case that the voltage difference between the drain electrode and the source electrode of the third switching transistor Q3 is less than the amplitude of the reference voltage signal, the body diode between the source electrode and the drain electrode of the third switching transistor Q3 is not turned on, which indicates that the dead time is too short. Therefore, the pulse width adjustment instruction generator circuit sends the second pulse width adjustment instruction to the signal processor 21 corresponding to the target switching transistor, i.e., the third switching transistor Q3, to instruct the signal processor 21 corresponding to the target switching transistor to increase the pulse with of the next input PWM signal.

In this way, the control sub-circuit adaptively regulates the dead time in real time based on the voltage signal at a terminal, close to an input terminal of the control sub-circuit, of the target switching transistor, until the voltage difference in the above embodiment is equal to the voltage of the body diode of the target switching transistor. In this way, the dead time is prevented from being set excessively large or excessively small, such that electromagnetic interference is prevented, and conversion efficiency of the charging circuit is improved.

An embodiment of the present disclosure provides a wireless charging transmitter circuit. The wireless charging transmitter circuit includes the oscillator circuit LC, the inverter circuit 11, the PWM signal processing circuit 20, and the wireless charging control circuit 30 according to the embodiment of the present disclosure.

An embodiment of the present disclosure provides a chip. The chip includes the wireless charging control circuit 30 according to the embodiments of the present disclosure, or the wireless charging transmitter circuit according to the embodiments of the present disclosure.

An embodiment of the present disclosure provides a wireless charger. The wireless charger includes the chip according to the embodiments of the present disclosure.

The features disclosed in the several circuit embodiments of the present disclosure may be freely combined to obtain new circuit embodiments, as long as there are no conflicts.

In summary, the above embodiments are used only for illustrating the present disclosure, but are not intended to limit the protection scope of the present disclosure. Various modifications and replacements readily derived by those skilled in the art within technical disclosure of the present disclosure shall fall within the protection scope of the present disclosure. Therefore, the protection scope of the present disclosure is subject to the appended claims.

What is claimed is:

1. A wireless charging control circuit, wherein the wireless charging control circuit is configured to receive a pulse width modulation (PWM) signal from an PWM signal processing circuit; and the wireless charging control circuit comprises an inverter circuit and an oscillator circuit; wherein
the inverter circuit comprises a first switching transistor, a second switching transistor, a third switching transistor, and a fourth switching transistor; wherein the first switching transistor, the oscillator circuit, and the fourth switching transistor are sequentially connected in series to form a first branch, and the second switching transistor, the oscillator circuit, and the third switching transistor are sequentially connected in series to form a second branch; wherein a first terminal of the first branch and a first terminal of the second branch are both connected to a DC power terminal, and a second terminal of the first branch and a second terminal of the second branch are both grounded;
the PWM signal processing circuit is configured to control the first branch and the second branch to be alternately turned on, to convert a DC voltage signal supplied by the DC power terminal into an AC voltage signal via the oscillator circuit and transmit the AC voltage signal to a wireless charging receiver circuit;
the wireless charging control circuit further comprises a control sub-circuit corresponding to a target switching transistor, and the PWM signal processing circuit comprises signal processors corresponding to the first switching transistor, the second switching transistor, the third switching transistor, and the fourth switching transistor respectively; wherein the target switching transistor is any one of the first switching transistor, the second switching transistor, the third switching transistor, and the fourth switching transistor; and an input terminal of the control sub-circuit is electrically connected to a first terminal of the target switching transistor, and an output terminal of the control sub-circuit is electrically connected to a signal processor corresponding to the target switching transistor; and
the control sub-circuit is configured to, prior to turn-on of the target switching transistor based on the received PWM signal, send a pulse width adjustment instruction to the signal processor corresponding to the target switching transistor based on a voltage difference between the first terminal of the target switching transistor and a second terminal of the target switching transistor, to instruct the signal processor corresponding to the target switching transistor to adjust a pulse width of a next PWM signal input to the target switching transistor based on the pulse width adjustment instruction.

2. The wireless charging control circuit according to claim 1, wherein the control sub-circuit comprises a sampler circuit, a comparator, and a pulse width adjustment instruction generator circuit; wherein
an input terminal of the sampler circuit is electrically connected to the first terminal of the target switching transistor, and another input terminal of the sampler circuit is electrically connected to the second terminal of the target switching transistor; an output terminal of the sampler circuit is electrically connected to a positive pin of the comparator; and a negative pin of the comparator is configured to receive a reference voltage signal, an output terminal of the comparator is connected to an input terminal of the pulse width adjustment instruction generator circuit, and an output terminal of the pulse width adjustment instruction generator circuit is electrically connected to the signal processor corresponding to the target switching transistor;
the sampler circuit is configured to, prior to turn-on of the target switching transistor, sample voltage signals at the first terminal of the target switching transistor and the second terminal of the target switching transistor, and output a voltage difference signal indicating a voltage difference between the first terminal of the target switching transistor and the second terminal of the target switching transistor;
the comparator is configured to output a comparison result to the pulse width adjustment instruction generator circuit based on the voltage difference signal and the reference voltage signal; and
the pulse width adjustment instruction generator circuit is configured to generate the pulse width adjustment instruction based on the comparison result.

3. The wireless charging control circuit according to claim 2, wherein the negative pin of the comparator is grounded via a reference voltage signal generator circuit, and the pulse width adjustment instruction comprises a first pulse width adjustment instruction and a second pulse width adjustment instruction; and
the pulse width adjustment instruction generator circuit is configured to: in a case that the comparison result indicates that an amplitude of the voltage difference signal is greater than an amplitude of the reference voltage signal output by the reference voltage signal generator circuit, send the first pulse width adjustment instruction to the signal processor corresponding to the target switching transistor, to instruct the signal processor corresponding to the target switching transistor to decrease a pulse width of a next output PWM signal; or
in a case that the comparison result indicates that an amplitude of the voltage difference signal is less than an amplitude of the reference voltage signal, send the second pulse width adjustment instruction to the signal processor corresponding to the target switching transistor, to instruct the signal processor corresponding to the target switching transistor to increase a pulse width of a next output PWM signal.

4. The wireless charging control circuit according to claim 2, wherein the first terminal of the target switching transistor is a terminal, close to the oscillator circuit, of the target switching transistor, and the second terminal of the target switching transistor is a terminal, away from the oscillator circuit, of the target switching transistor.

5. The wireless charging control circuit according to claim 4, wherein the target switching transistor is a switching transistor close to the DC power terminal, and the sampler circuit comprises a first switch, a second switch, a third switch, a fourth switch, and a first capacitor; wherein
a first terminal of the first switch, as one input terminal of the sampler circuit, is electrically connected to the first terminal of the target switching transistor, a first terminal of the second switch, as another input terminal of the sampler circuit, is electrically connected to the direct current power terminal, a second terminal of the first switch is electrically connected to a second terminal of the second switch via the first capacitor, the second terminal of the first switch is further electrically connected to the positive pin of the comparator via the third switch, and the second terminal of the second switch is further electrically connected to a ground via the fourth switch;
the first switch and the second switch are turned on prior to turn-on of the target switching transistor and the first capacitor is charged, such that a voltage difference between two terminals of the first capacitor is equal to a voltage difference between the first terminal of the target switching transistor and the second terminal of the target switching transistor; and
the third switching transistor and the fourth switching transistor are turned on in a case that the voltage difference between two terminals of the first capacitor is equal to the voltage difference between the first terminal of the target switching transistor and the second terminal of the target switching transistor, such that the first capacitor is discharged and the voltage difference signal is input to the positive pin of the comparator.

6. The wireless charging control circuit according to claim 5, wherein in a case that the first switch and the second switch are turned on such that the first capacitor is charged, the third switch and the fourth switch are in a turned-off state; and in a case that the first capacitor is charged such that a voltage difference between the two terminals of the first capacitor is equal to the voltage difference between the first terminal and the second terminal of the target switching transistor, the first switch and the second switch are turned off, and the third switch and the fourth switch are turned on, such that the first capacitor is discharged.

7. The wireless charging control circuit according to claim 4, wherein the target switching transistor is a switching transistor close to a ground, and the sampler circuit comprises a first switch, a second switch, a third switch, a fourth switch, and a first capacitor; wherein
a first terminal of the first switch, as one input terminal of the sampler circuit, is electrically connected to the ground, a first terminal of the second switch, as another input terminal of the sampler circuit, is electrically connected to the first terminal of the target switching transistor, a second terminal of the first switch is electrically connected to a second terminal of the second switch via the first capacitor, the second terminal of the first switch is further electrically connected to the positive pin of the comparator via the third switch, and the second terminal of the second switch is further electrically connected to the ground via the fourth switch;
the first switch and the second switch are turned on prior to turn-on of the target switching transistor such that the first capacitor is charged, such that a voltage difference between two terminals of the charged first capacitor is equal to a voltage difference between the first terminal of the target switching transistor and the second terminal of the target switching transistor; and
the third switch and the fourth switch are turned on in a case that the voltage difference between two terminals of the first capacitor is equal to the voltage difference between the first terminal of the target switching transistor and the second terminal of the target switching transistor, such that the first capacitor is discharged and the voltage difference signal is input to the positive pin of the comparator.

8. The wireless charging control circuit according to claim 7, wherein in a case that the first switch and the second switch are turned on such that the first capacitor is charged, the third switch and the fourth switch are in a turned-off state; and in a case that the first capacitor is charged such that a voltage difference between the two terminals of the first capacitor is equal to the voltage difference between the first terminal and the second terminal of the target switching transistor, the first switch and the second switch are turned off, and in the meantime, the third switch and the fourth switch are turned on, such that the first capacitor is discharged.

9. The wireless charging control circuit according to claim 5, wherein an amplitude of the reference voltage signal output by the reference signal generator circuit is less than or equal to a turn-on voltage of a body diode of the target switching transistor.

10. The wireless charging control circuit according to claim 5, wherein the comparator is configured to output a high level in a case that an amplitude of the voltage difference signal is greater than an amplitude of the reference voltage signal, and the pulse width adjustment instruction generator circuit is configured to send the first pulse width adjustment instruction to the signal processor corresponding to the target switching transistor based on the high level signal so as to instruct the signal processor corresponding to the target switching transistor to decrease the pulse width of the next output PWM signal; or
the comparator is configured to output a low level in a case that an amplitude of the voltage difference signal is less than an amplitude of the reference voltage signal, and the pulse width adjustment instruction generator circuit is configured to send the second pulse width adjustment instruction to the signal processor corresponding to the target switching transistor based on the low level signal so as to instruct the signal processor corresponding to the target switching transistor to increase the pulse width of the next output PWM signal.

11. The wireless charging control circuit according to claim 1, wherein the signal processor corresponding to the target switching transistor is configured to shorten a pulse width of the PWM signal and send the PWM signal to the target switching transistor, such that a dead time is caused between the first branch and the second branch, and thus the first branch and the second branch are alternately turned on.

12. A wireless charging transmitter circuit, comprising: an inverter circuit, an oscillator circuit, a pulse width modulation (PWM) signal processing circuit, and a wireless charging control circuit; wherein
the wireless charging control circuit is configured to receive a PWM signal from the PWM signal processing circuit;
the wireless charging control circuit comprises an inverter circuit and an oscillator circuit;
wherein the inverter circuit comprises a first switching transistor, a second switching transistor, a third switching transistor, and a fourth switching transistor;
wherein the first switching transistor, the oscillator circuit, and the fourth switching transistor are sequentially connected in series to form a first branch, and the second switching transistor, the oscillator circuit, and the third switching transistor are sequentially connected in series to form a second branch; wherein a first terminal of the first branch and a first terminal of the second branch are both connected to a DC power terminal, and a second terminal of the first branch and a second terminal of the second branch are both grounded;
the PWM signal processing circuit is configured to control the first branch and the second branch to be alternately turned on, to convert a DC voltage signal supplied by the DC power terminal into an AC voltage signal via the oscillator circuit and transmit the AC voltage signal to a wireless charging receiver circuit;
the wireless charging control circuit further comprises a control sub-circuit corresponding to a target switching transistor, and the PWM signal processing circuit comprises signal processors corresponding to the first switching transistor, the second switching transistor, the third switching transistor, and the fourth switching transistor respectively; wherein the target switching transistor is any one of the first switching transistor, the second switching transistor, the third switching transistor, and the fourth switching transistor; and an input terminal of the control sub-circuit is electrically connected to a first terminal of the target switching transistor, and an output terminal of the control sub-circuit is electrically connected to a signal processor corresponding to the target switching transistor; and
the control sub-circuit is configured to, prior to turn-on of the target switching transistor based on the received PWM signal, send a pulse width adjustment instruction to the signal processor corresponding to the target switching transistor based on a voltage difference between the first terminal of the target switching transistor and a second terminal of the target switching transistor, to instruct the signal processor corresponding to the target switching transistor to adjust a pulse width of a next PWM signal input to the target switching transistor based on the pulse width adjustment instruction.

13. The wireless charging transmitter circuit according to claim 12, wherein the control sub-circuit comprises a sampler circuit, a comparator, and a pulse width adjustment instruction generator circuit; wherein
an input terminal of the sampler circuit is electrically connected to the first terminal of the target switching transistor, and another input terminal of the sampler circuit is electrically connected to the second terminal of the target switching transistor; an output terminal of the sampler circuit is electrically connected to a positive pin of the comparator; and a negative pin of the comparator is configured to receive a reference voltage signal, an output terminal of the comparator is connected to an input terminal of the pulse width adjustment instruction generator circuit, and an output terminal of the pulse width adjustment instruction generator circuit is electrically connected to the signal processor corresponding to the target switching transistor;
the sampler circuit is configured to, prior to turn-on of the target switching transistor, sample voltage signals at the first terminal of the target switching transistor and the second terminal of the target switching transistor, and output a voltage difference signal indicating a voltage difference between the first terminal of the target switching transistor and the second terminal of the target switching transistor;
the comparator is configured to output a comparison result to the pulse width adjustment instruction generator circuit based on the voltage difference signal and the reference voltage signal; and
the pulse width adjustment instruction generator circuit is configured to generate the pulse width adjustment instruction based on the comparison result.

14. The wireless charging transmitter circuit according to claim 13, wherein the negative pin of the comparator is grounded via a reference voltage signal generator circuit, and the pulse width adjustment instruction comprises a first pulse width adjustment instruction and a second pulse width adjustment instruction; and
the pulse width adjustment instruction generator circuit is configured to:
in a case that the comparison result indicates that an amplitude of the voltage difference signal is greater than an amplitude of the reference voltage signal output by the reference voltage signal generator circuit, send the first pulse width adjustment instruction to the signal processor corresponding to the target switching transistor, to instruct the signal processor corresponding to the target switching transistor to decrease a pulse width of a next output PWM signal; or
in a case that the comparison result indicates that an amplitude of the voltage difference signal is less than an amplitude of the reference voltage signal, send the second pulse width adjustment instruction to the signal processor corresponding to the target switching transistor, to instruct the signal processor corresponding to the target switching transistor to increase a pulse width of a next output PWM signal.

15. The wireless charging transmitter circuit according to claim 13, wherein the first terminal of the target switching transistor is a terminal, close to the oscillator circuit, of the target switching transistor, and the second terminal of the target switching transistor is a terminal, away from the oscillator circuit, of the target switching transistor.

16. The wireless charging transmitter circuit according to claim 15, wherein the target switching transistor is a switching transistor close to the DC power terminal, and the sampler circuit comprises a first switch, a second switch, a third switch, a fourth switch, and a first capacitor; wherein
a first terminal of the first switch, as one input terminal of the sampler circuit, is electrically connected to the first terminal of the target switching transistor, a first terminal of the second switch, as another input terminal of the sampler circuit, is electrically connected to the direct current power terminal, a second terminal of the first switch is electrically connected to a second terminal of the second switch via the first capacitor, the second terminal of the first switch is further electrically connected to the positive pin of the comparator via the third switch, and the second terminal of the second switch is further electrically connected to a ground via the fourth switch;
the first switch and the second switch are turned on prior to turn-on of the target switching transistor such that the first capacitor is charged, thus a voltage difference between two terminals of the first capacitor is equal to a voltage difference between the first terminal of the target switching transistor and the second terminal of the target switching transistor; and
the third switching transistor and the fourth switching transistor are turned on in a case that the voltage difference between two terminals of the first capacitor is equal to the voltage difference between the first terminal of the target switching transistor and the second terminal of the target switching transistor, such that the first capacitor is discharged and the voltage difference signal is input to the positive pin of the comparator.

17. The wireless charging transmitter circuit according to claim 15, wherein the target switching transistor is a switching transistor close to a ground, and the sampler circuit comprises a first switch, a second switch, a third switch, a fourth switch, and a first capacitor; wherein
a first terminal of the first switch, as one input terminal of the sampler circuit, is electrically connected to the ground, a first terminal of the second switch, as another input terminal of the sampler circuit, is electrically connected to the first terminal of the target switching transistor, a second terminal of the first switch is electrically connected to a second terminal of the second switch via the first capacitor, the second terminal of the first switch is further electrically connected to the positive pin of the comparator via the third switch, and the second terminal of the second switch is further electrically connected to the ground via the fourth switch;
the first switch and the second switch are turned on prior to turn-on of the target switching transistor such that the first capacitor is charged, such that a voltage difference between two terminals of the charged first capacitor is equal to a voltage difference between the first terminal of the target switching transistor and the second terminal of the target switching transistor; and
the third switch and the fourth switch are turned on in a case that the voltage difference between two terminals of the first capacitor is equal to the voltage difference between the first terminal of the target switching transistor and the second terminal of the target switching transistor, such that the first capacitor is discharged and the voltage difference signal is input to the positive pin of the comparator.

18. The wireless charging transmitter circuit according to claim 16, wherein the comparator is configured to output a high level in a case that an amplitude of the voltage difference signal is greater than an amplitude of the reference voltage signal, and the pulse width adjustment instruction generator circuit is configured to send the first pulse width adjustment instruction to the signal processor corresponding to the target switching transistor based on the high level signal so as to instruct the signal processor corresponding to the target switching transistor to decrease the pulse width of the next output PWM signal; or
the comparator is configured to output a low level in a case that an amplitude of the voltage difference signal is less than an amplitude of the reference voltage signal, and the pulse width adjustment instruction generator circuit is configured to send the second pulse width adjustment instruction to the signal processor corresponding to the target switching transistor based on the low level signal so as to instruct the signal processor corresponding to the target switching transistor to increase the pulse width of the next output PWM signal.

19. The wireless charging transmitter circuit according to claim 12, wherein the signal processor corresponding to the target switching transistor is configured to shorten a pulse width of the PWM signal and then send the PWM signal to the target switching transistor, such that a dead time is caused between the first branch and the second branch, and thus the first branch and the second branch are alternately turned on.

20. A chip, comprising: an inverter circuit, an oscillator circuit, a pulse width modulation (PWM) signal processing circuit, and a wireless charging control circuit; wherein
the wireless charging control circuit is configured to receive an PWM signal from the PWM signal processing circuit;
the wireless charging control circuit comprises an inverter circuit and an oscillator circuit;
the inverter circuit comprises a first switching transistor, a second switching transistor, a third switching transistor, and a fourth switching transistor;
the first switching transistor, the oscillator circuit, and the fourth switching transistor are sequentially connected in series to form a first branch, and the second switching transistor, the oscillator circuit, and the third switching transistor are sequentially connected in series to form a second branch; wherein a first terminal of the first branch and a first terminal of the second branch are both connected to a DC power terminal, and a second terminal of the first branch and a second terminal of the second branch are both grounded;
the PWM signal processing circuit is configured to control the first branch and the second branch to be alternately turned on, to convert a DC voltage signal supplied by the DC power terminal into an AC voltage signal via the oscillator circuit and transmit the AC voltage signal to a wireless charging receiver circuit;
the wireless charging control circuit further comprises a control sub-circuit corresponding to a target switching transistor, and the PWM signal processing circuit comprises signal processors corresponding to the first switching transistor, the second switching transistor, the third switching transistor, and the fourth switching transistor respectively; wherein the target switching transistor is any one of the first switching transistor, the second switching transistor, the third switching transistor, and the fourth switching transistor; and an input terminal of the control sub-circuit is electrically connected to a first terminal of the target switching transistor, and an output terminal of the control sub-circuit is electrically connected to a signal processor corresponding to the target switching transistor; and
the control sub-circuit is configured to, prior to turn-on of the target switching transistor based on the received PWM signal, send a pulse width adjustment instruction to the signal processor corresponding to the target switching transistor based on a voltage difference between the first terminal of the target switching transistor and a second terminal of the target switching transistor, to instruct the signal processor corresponding to the target switching transistor to adjust a pulse width of a next PWM signal input to the target switching transistor based on the pulse width adjustment instruction.
